(19) United States
(12) Patent Application Publication
(10) Pub. No.: US 2026/0045528 A1
(43) Pub. Date: Feb. 12, 2026

(54) Liquid Delivery System for Low-Pressure Cathodes in Electrochemical Hydrogen Expanders

(71) Applicant: JTEC ENERGY, INC., Atlanta, GA (US)

(72) Inventors: Abhijeet MANIKTALA, Atlanta, GA (US); Devin BRAND, Newnan, GA (US)

(21) Appl. No.: 19/290,962

(22) Filed: Aug. 5, 2025

Related U.S. Application Data
(60) Provisional application No. 63/680,282, filed on Aug. 7, 2024.

(51) Int. Cl. H01M 8/04119; H01M 8/1004

(52) U.S. Cl. CPC H01M 8/04141; H01M 8/1004

(57) ABSTRACT

An electrochemical cell includes a membrane electrode assembly having a first electrode operating at a first pressure, a second electrode operating at a second pressure that is lower than the first pressure, and a proton exchange membrane disposed between the first and second electrodes. The first and second electrodes are electrically connected to an external load. The second electrode has a liquid inlet and a liquid outlet. A first conduit is in communication with the first electrode and supplies a dry or humidified gas to the first electrode. A second conduit is in communication with the second electrode. The second conduit provides an outlet for gas products produced by electrochemical reactions across the MEA. A liquid reservoir contains a liquid and is in fluid communication with the second electrode via the liquid inlet and the liquid outlet to enable circulation of the liquid within the second electrode.

### CROSS-REFERENCE TO RELATED APPLICATIONS

This application claims the benefit of U.S. Provisional Ser. No. 63/680,282, filed Aug. 7, 2024, entitled “Liquid Water Delivery System for Low-Pressure Cathodes in Electrochemical Hydrogen Expanders,” currently pending, the entire contents of which are incorporated by reference herein.

### BACKGROUND

Embodiments described herein relate generally to electrochemical cells, and more particularly, to a system for delivering a liquid to electrochemical cells to maintain optimal operating conditions.

Electrochemical hydrogen expanders (EHEs) generate power from a voltage potential described by the Nernst equation, which creates an electric current that is proportional to the EHE's electronic and ionic resistance. Within EHEs, proton-exchange membranes (PEMs) require hydration to facilitate the transport of H+ ions. These ions split at the anode from a hydrogen oxidation reaction (HOR) and recombine at the cathode in a hydrogen evolution reaction (HER). Gas diffusion electrodes (GDEs), which catalyze these reactions, also help carry current to current collectors within EHEs. A PEM sandwiched between two GDEs makes a membrane electrode assembly (MEA). These systems can suffer from the PEM drying out. The phenomenon that leads to this type of drying is referred to as electro-osmotic drag (EOD). As the protons generated at the anode through HOR move through the PEM during operation, they drag surrounding water molecules with them, depleting the amount of available water at the anode side.

To increase the power density from the EHE, the pressure differential across the anode and cathode can be increased. The high-pressure hydrogen stream being brought into the EHE at the anode can be sent through a sparger to, for example, humidify the stream and provide hydration to the MEA. In another example method, water-vapor can be delivered to the cathode with a humidified gas stream using an auxiliary pump. Another option combines these two techniques. However, the mass fraction of water being brought in is less than that of which can leave through the low-pressure stream. This leads to the PEM drying out over time (and the MEA along with it) and a subsequent decay in proton conductivity as low-temperature (LT) PEMs rely on water.

It is desirable to provide a system and method for maintaining an optimal level of a liquid within the PEM that does not adversely impact operation of an electrochemical cell.

### BRIEF SUMMARY

Briefly stated, one embodiment comprises an electrochemical cell that includes a membrane electrode assembly (MEA) having a first electrode operating at a first pressure, a second electrode operating at a second pressure that is lower than the first pressure, and a proton exchange membrane (PEM) disposed between the first and second electrodes. The first and second electrodes are electrically connected to an external load. The second electrode has a liquid inlet and a liquid outlet. A first conduit is in communication with the first electrode and supplies a dry or humidified gas to the first electrode. A second conduit is in communication with the second electrode. The second conduit provides an outlet for gas products produced by electrochemical reactions across the MEA. A liquid reservoir contains a liquid and is in fluid communication with the second electrode via the liquid inlet and the liquid outlet to enable circulation of the liquid within the second electrode.

In one aspect, the electrochemical cell further includes a liquid pump configured to move the liquid between the liquid reservoir and the liquid inlet of the second electrode. In a further aspect, the electrochemical cell further includes a controller operatively connected to the liquid pump. The controller is configured to adjust a speed of the liquid pump. In a still further aspect, the electrochemical cell further includes one or more sensors operatively connected to the controller. The controller is configured to determine, based on data received from the one or more sensors, one or more operating parameters of the electrochemical cell, and to adjust the speed of the liquid pump based on the one or more operating parameters. In a still further aspect, the one or more operating parameters include at least one of an operating current density of the electrochemical cell, a differential between the first pressure and the second pressure, or a liquid concentration gradient across the MEA. In a further aspect, the liquid pump is a reversible pump.

In another aspect, the liquid reservoir is positioned at a height above the liquid inlet of the second electrode to enable gravity-fed delivery of the liquid to the second electrode. In a further aspect, the liquid reservoir is further positioned at a height below the liquid outlet of the second electrode.

In yet another aspect, the liquid is deionized liquid water.

In still another aspect, the liquid outlet of the second electrode is in fluid communication with the second conduit and the liquid reservoir is in fluid communication with the second conduit.

Another embodiment comprises a method of operating an electrochemical cell having a membrane electrode assembly (MEA) including a proton exchange membrane (PEM) disposed between a first electrode and a second electrode, a first conduit in communication with the first electrode, a second conduit in communication with the second electrode, and a liquid reservoir containing a liquid. The first and second electrodes are electrically connected to an external load. The method includes introducing, via the first conduit, a dry or humidified gas to the first electrode and maintaining the first electrode at a first pressure and the second electrode at a second pressure that is lower than the first pressure so that a current flows between the first and second electrodes to the external load as a result of the introduced gas undergoing an electrochemical reaction across the MEA, providing an outlet for gas products produced by the electrochemical reaction through the second conduit, providing the liquid from the liquid reservoir to the second electrode via a liquid inlet of the second electrode, and recycling the liquid to the liquid reservoir from the second electrode via a liquid outlet of the second electrode.

In one aspect, a liquid pump is used to provide the liquid from the liquid reservoir to the liquid inlet of the second electrode. In a further aspect, the method further includes adjusting, by a controller operatively connected to the liquid pump, a speed of the liquid pump. In a still further aspect, the method further includes determining, by a controller based on data received from one or more sensors, one or more operating parameters of the electrochemical cell, and adjusting the speed of the liquid pump based on the one or more operating parameters. In a still further aspect, the one or more operating parameters include at least one of an operating current density of the electrochemical cell, a differential between the first pressure and the second pressure, or a liquid concentration gradient across the MEA.

In another aspect, providing the liquid from the liquid reservoir to the liquid inlet of the second electrode is via gravity feed. The liquid reservoir is positioned at a height above the liquid inlet of the second electrode. In a further aspect, the liquid reservoir is further positioned at a height below the liquid outlet of the second electrode.

In yet another aspect, the liquid is deionized liquid water.

In still another aspect, the recycling of the liquid to the liquid reservoir via the liquid outlet includes providing the liquid from the liquid outlet to the second conduit and providing the liquid from the second conduit to the liquid reservoir.

### BRIEF DESCRIPTION OF THE SEVERAL VIEWS OF THE DRAWINGS

The following detailed description of preferred embodiments will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic block diagram of a pump-driven electrochemical cell in accordance with a first example embodiment;

FIG. 2 is a schematic block diagram of the electrochemical cell of FIG. 1 with an example control arrangement for the pump; and

FIG. 3 is a schematic block diagram of a gravity-fed electrochemical cell in accordance with a second example embodiment.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

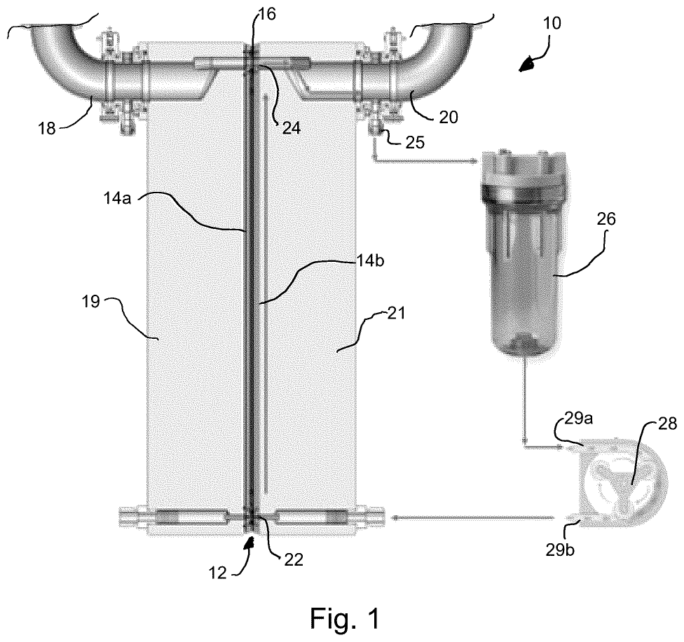

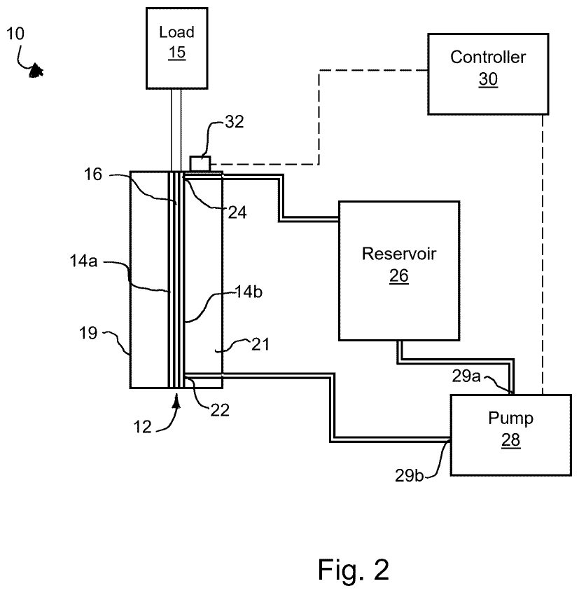

Referring to the drawings in detail, wherein like reference numerals indicate like elements throughout, there is shown in FIGS. 1-2 an electrochemical cell 10 in accordance with an example embodiment. The electrochemical cell 10 may be an EHE, although other similar types of electrochemical cells may be provided and utilized in the manner described herein. The electrochemical cell 10 may include an MEA 12 formed by a first electrode 14a, a second electrode 14b, and a PEM 16 disposed between the first and second electrodes 14a, 14b. The first and second electrodes 14a, 14b may be connected to an external electrical load 15 that is powered by the electrochemical cell 10 and/or stores electrical energy produced by the electrochemical cell 10.

The first and second electrodes 14a, 14b may be made from a mixture of platinum on carbon (Pt/C) powder along with an ionomer binder and various solvents. For example, the first and second electrodes 14a, 14b may be formed by a mixture of 20% Pt/C powder, a Nafion ionomer binder (1100 equivalent weight), isopropyl alcohol, and water. However, other materials may be used to form the electrodes 14a, 14b as well. The first and second electrodes 14a, 14b may be porous and have a thickness of generally about 1-3 micrometers, although other thicknesses may be used as well.

The PEM 16 may be a membrane made from Nafion or other like polymeric materials and may have a thickness extending between the first and second electrodes 14a, 14b of about 8 to about 75 micrometers, preferably about 15 micrometers, although other thicknesses may be used as well.

A first conduit 18 may be in communication with the first electrode 14a so as to supply a dry or humidified gas to the first electrode 14a. The gas is preferably dry or humidified hydrogen gas, although other gases may be used as well. The first electrode 14a may be provided in a first chamber 19 or similar enclosure to prevent contamination from other materials and to allow the first electrode 14a to operate at a first pressure. For example, the first electrode 14a may be subject to a first pressure in a range of about 100-500 PSIA during operation in order to facilitate the electrochemical reactions described herein, although other pressures may be used depending on the nature of the electrodes 14a, 14b and/or the PEM 16, the gas, or other operating conditions and results. In conjunction, the second electrode 14b may be operated at a second pressure that is lower than the first pressure, such as in a range of about 5-15 PSIA, although, again, other pressures may be used.

In operation, the first electrode 14a may function as an anode and oxidize the gas brought into contact with the first electrode 14a by the first conduit 18. The stripped electrons may flow in the electrical circuit created by the first and second electrodes 14a, 14b with the external load 15. Under the pressure differential between the first and second electrodes 14a, 14b, the gas ions (e.g., H⁺ions) traverse the MEA 12 and recombine with electrons at the second electrode 14b, acting as a cathode, to form gas products of the electrochemical reactions across the MEA 12. A second conduit 20 may be in communication with the second electrode 14b to provide an outlet for the gas products and to maintain the operating pressure of the second electrode 14b. As with the first electrode 14a, the second electrode 14b may be disposed within a second chamber 21 or similar enclosure to prevent contamination from other materials.

To prevent the PEM 16 from drying out, a liquid (preferably deionized water, although other acceptable liquids may be used as well, such as liquid water with acidic or basic ions, a plasticizer, or the like) may be supplied thereto. A combination of temperature and second electrode 14b pressure should therefore be kept within the range for which the liquid remains in its liquid state. For example, for water as the liquid, the temperature could be 25° C. at a second electrode pressure of 8 PSIA, or 80° C. at a pressure of 14 PSIA, or the like. But, for example, a temperature should not be 120° C. at a second electrode pressure of 14 PSIA, because the water would boil and quickly turn to steam. To deliver the liquid, the second electrode 14b may include a liquid inlet 22 to allow fluid communication to a cavity (not shown) within the second electrode 14b. A liquid reservoir 26 containing the liquid may be in fluid communication with the second electrode 14b via the liquid inlet 22 (directly or indirectly, such as through connecting tubes or the like). The liquid is able to enter the second electrode 14b and contact the PEM 16. As the liquid is carried out of the MEA through EOD during operation, liquid supplied from the liquid reservoir 26 can back diffuse into the PEM 16 due to a concentration gradient and keep the PEM from drying out.

Where deionized water is used as the liquid, it may be necessary to include a deionizer (not shown), which may be inline between the liquid reservoir 26 and the liquid inlet 22, for example. In other embodiments, the liquid reservoir 26 may have internal deionizing capabilities so that the water output to the liquid inlet 22 is deionized.

The second electrode 14b further preferably may include a liquid outlet 24 to allow fluid communication out of the cavity of the second electrode 14b. Liquid that exits the MEA 12 at the second electrode 14b can therefore be circulated back to the liquid reservoir 26 for reuse, creating a liquid loop with the second electrode 14b. In some embodiments, such as that shown in FIG. 1, the liquid outlet 24 may be in fluid communication with the second conduit 20. In this manner, evacuation of gas products and liquid from the second electrode 14b and the second chamber 21 may be consolidated, which also offers the opportunity to recover liquid through condensation that might have otherwise been carried away by the gas products. For example, the second conduit 20 may include a liquid port 25 downstream from the second chamber 21 that allows any liquid received by the liquid outlet 24 and/or condensed from the gas products to exit the second conduit 20 toward the liquid reservoir 26 while the gas products proceed further through the second conduit 20. However, it is also possible that the liquid outlet 24 and the second conduit 20 may be separate from one another.

The electrochemical cell 10 in FIGS. 1 and 2 utilizes a liquid pump 28 to move the liquid between the liquid reservoir 26 and the liquid inlet 22 of the second electrode 14b. For example, the liquid pump 28 may be a positive displacement-type pump, such as a peristaltic pump or the like, and may be speed adjustable, as described in more detail below. The liquid pump 28 may also preferably be reversible (e.g., the pump connects with a reversible motor) so that excess liquid can be withdrawn from the liquid inlet 22 back into the liquid reservoir 26, if necessary. However, other types of pumps may be used as well. In the example shown in FIGS. 1-2, the liquid pump 28 has an inlet 29a connected to the liquid reservoir 26 and an outlet 29b connected to the liquid inlet 22 of the second electrode 14b. Tubing or other fluid connectors may be used to make the connections to the liquid pump 28. However, other arrangements for connecting the liquid pump 28 for moving liquid between the liquid reservoir 26 and the second electrode 22 may be used as well.

The liquid pump 28 may be operated by a controller 30 operatively connected thereto. The controller 30 may be configured to send instructions to, or otherwise cause, the liquid pump 28 to turn on or off, adjust speed, enter forward or reverse operation, perform priming, run diagnostics, and/or the like. The controller 30 may be a microcontroller unit (MCU), a central processing unit (CPU), a microprocessor, an application specific controller (ASIC), a programmable logic array (PLA), combinations thereof, or the like. The controller 30 may include or be coupled to a memory (not shown) that may store code or software for carrying out processes described herein and/or carrying out other operations of the electrochemical cell 10 and may store any captured data for later transfer to remote or external devices. It should be further appreciated that although controller 30 is referred to in this example as a single component, the controller 30 may include a plurality of individual devices, with control functions divided among the individual devices. The controller 30 may be wired or wirelessly connected to liquid pump 28 and/or other components of the electrochemical cell 10 necessary for carrying out the operations and processes described herein. In some embodiments, the controller 30 may be housed with the liquid pump 28, but it is also possible for the controller 30 to be housed separately and connected to the liquid pump 28 via wired or wireless connections.

One benefit of using a controller 30 is to be able to adjust delivery of the liquid to the second electrode 14b in response to changing conditions. Accordingly, one or more sensors 32 may be distributed at appropriate locations on or within the electrochemical cell 10 and operatively connected to the controller 30 for reporting data related to various conditions of the electrochemical cell 10. For example, the one or more sensors 32 may include one or more of current sensors, resistance sensors, voltage sensors, pressure sensors, flow rate sensors, temperature sensors, or the like. The controller 30 may be configured to determine one or more operating parameters of the electrochemical cell 10 based on the data received from the one or more sensors 32. The one or more parameters may include at least one of an operating current density of the electrochemical cell 10, a differential between the first pressure and the second pressure, a liquid concentration gradient across the MEA 12, and/or the like. The controller 30 may, for example, store or have access to preset thresholds or lookup tables indicating appropriate speeds for the liquid pump 28 based on various detected operating parameters and may adjust the speed of the liquid pump 28 accordingly to optimize performance.

As one example, the controller 30 may calculate the total molar flow rate of water using steam tables to find water saturation pressure and calculate partial pressures of water and hydrogen. The pump 28 may then be operated at a speed to maintain an optimal molar flow rate based on the results. This method assumes that hydrogen gas leaving the system is saturated (i.e., 100% relative humidity) and does not account for a concentration gradient across the MEA 12. In another example, the current density and active area of the second electrode 14b may be determined and the electro-osmotic drag coefficient may be used to calculate how much water is being carried to the second electrode 14b, and the pump 28 may be operated accordingly by the controller 30. This method is able to account for concentration gradients. However, other methods for the controller 30 to utilize sensor data to optimize pump 28 speeds may be used.

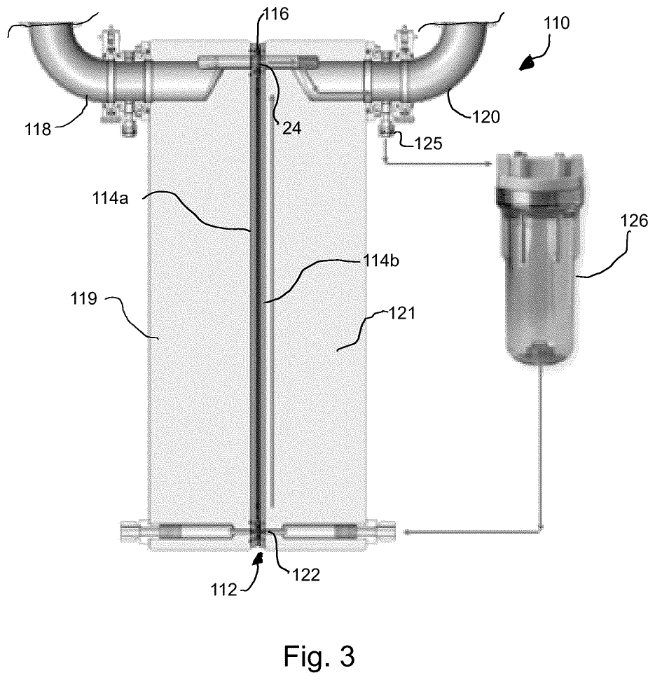

FIG. 3 shows an alternative example embodiment of an electrochemical cell 110 wherein the liquid is gravity-fed. The electrochemical cell 110 may include a number of elements similar to those described above for the electrochemical cell 10 in FIGS. 1 and 2. Therefore, like numerals have been used for the electrochemical cell 110, except the 100 series numerals have been used. Accordingly, a complete description of the electrochemical cell 110 shown in FIG. 3 has been omitted, with mainly the differences being described.

Gravity feeding of the liquid to the second electrode 114b may be utilized when the liquid reservoir 126 can be positioned at a height above the liquid inlet 122 of the second electrode 114b (as shown in FIG. 3, for example) and the gas products generated by the electrochemical reactions of the MEA 112 are able to evacuate upward. As such, the liquid inlet 122 may be placed at or near a bottom of the second electrode 114b and a bottom of the liquid reservoir 126 (or at the very least, the level of the liquid within the liquid reservoir 126) may be positioned at a suitable height above the liquid inlet 122.

The liquid reservoir 126 may also be positioned at a height below the liquid outlet 124 of the second electrode 114b (which covers instances where the entire liquid reservoir 126 or, at the very least, the level of the liquid therein, is below the liquid outlet 124). In this manner, liquid exiting the second electrode 114b may run downhill to the liquid reservoir 126, which also enables separation from any gas products resulting from the electrochemical reaction. Although not shown in the example embodiment of FIG. 3, the height of the liquid reservoir 126 may be adjustable, such as by a controller and motor (not shown in FIG. 3) or the like, to optimize liquid flow to the second electrode 114b. One or more sensors (not shown in FIG. 3) may be used in a feedback loop, similar to those described above in relation to the FIGS. 1-2 embodiment, to allow the controller to determine the necessary height for the liquid reservoir 126.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the invention. Thus, an individual feature described herein only with respect to one embodiment should not be construed as being incompatible with other embodiments described herein or otherwise encompassed by the invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

We claim:

1. An electrochemical cell comprising:
a membrane electrode assembly (MEA) including a first electrode operating at a first pressure, a second electrode operating at a second pressure that is lower than the first pressure, and a proton exchange membrane (PEM) disposed between the first and second electrodes, the first and second electrodes being electrically connected to an external load, the second electrode having a liquid inlet and a liquid outlet;
a first conduit in communication with the first electrode and supplying a dry or humidified gas to the first electrode;
a second conduit in communication with the second electrode, the second conduit providing an outlet for gas products produced by electrochemical reactions across the MEA; and
a liquid reservoir containing a liquid, the liquid reservoir being in fluid communication with the second electrode via the liquid inlet and the liquid outlet to enable circulation of the liquid within the second electrode.

2. The electrochemical cell of claim 1, further comprising a liquid pump configured to move liquid between the liquid reservoir and the liquid inlet of the second electrode.

3. The electrochemical cell of claim 2, further comprising a controller operatively connected to the liquid pump, the controller being configured to adjust a speed of the liquid pump.

4. The electrochemical cell of claim 3, further comprising one or more sensors operatively connected to the controller, the controller being configured to determine, based on data received from the one or more sensors, one or more operating parameters of the electrochemical cell, and to adjust the speed of the liquid pump based on the one or more operating parameters.

5. The electrochemical cell of claim 4, wherein the one or more operating parameters include at least one of an operating current density of the electrochemical cell, a differential between the first pressure and the second pressure, or a liquid concentration gradient across the MEA.

6. The electrochemical cell of claim 2, wherein the liquid pump is a reversible pump.

7. The electrochemical cell of claim 1, wherein the liquid reservoir is positioned at a height above the liquid inlet of the second electrode to enable gravity-fed delivery of the liquid to the second electrode.

8. The electrochemical cell of claim 7, wherein the liquid reservoir is further positioned at a height below the liquid outlet of the second electrode.

9. The electrochemical cell of claim 1, wherein the liquid is deionized liquid water.

10. The electrochemical cell of claim 1, wherein the liquid outlet of the second electrode is in fluid communication with the second conduit and the liquid reservoir is in fluid communication with the second conduit.

11. A method of operating an electrochemical cell having a membrane electrode assembly (MEA) including a proton exchange membrane (PEM) disposed between a first electrode and a second electrode, a first conduit in communication with the first electrode, a second conduit in communication with the second electrode, and a liquid reservoir containing a liquid, the first and second electrodes being electrically connected to an external load, the method comprising:
introducing, via the first conduit, a dry or humidified gas to the first electrode and maintaining the first electrode at a first pressure and the second electrode at a second pressure that is lower than the first pressure so that a current flows between the first and second electrodes to the external load as a result of the introduced gas undergoing an electrochemical reaction across the MEA;
providing an outlet for gas products produced by the electrochemical reaction through the second conduit;
providing the liquid from the liquid reservoir to the second electrode via a liquid inlet of the second electrode; and
recycling the liquid to the liquid reservoir from the second electrode via a liquid outlet of the second electrode.

12. The method of claim 11, wherein a liquid pump is used to provide the liquid from the liquid reservoir to the liquid inlet of the second electrode.

13. The method of claim 12, further comprising adjusting, by a controller operatively connected to the liquid pump, a speed of the liquid pump.

14. The method of claim 13, further comprising determining, by a controller based on data received from one or more sensors, one or more operating parameters of the electrochemical cell; and
adjusting the speed of the liquid pump based on the one or more operating parameters.

15. The method of claim 14, wherein the one or more operating parameters include at least one of an operating current density of the electrochemical cell, a differential between the first pressure and the second pressure, or a liquid concentration gradient across the MEA.

16. The method of claim 11, wherein providing the liquid from the liquid reservoir to the liquid inlet of the second electrode is via gravity feed, the liquid reservoir being positioned at a height above the liquid inlet of the second electrode.

17. The method of claim 16, wherein the liquid reservoir is further positioned at a height below the liquid outlet of the second electrode.

18. The method of claim 11, wherein the liquid is deionized liquid water.

19. The method of claim 11, wherein the recycling of the liquid to the liquid reservoir via the liquid outlet includes providing the liquid from the liquid outlet to the second conduit and providing the liquid from the second conduit to the liquid reservoir.
